(19) United States
(12) Patent Application Publication
(10) Pub. No.: US 2008/0308425 A1
(43) Pub. Date: Dec. 18, 2008

(54) CORROSION AND WEAR RESISTANT COATING FOR MAGNETIC STEEL

(75) Inventors: Don L. Mittendorf, Mesa, AZ (US); Amer Aizaz, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/761,921

(22) Filed: Jun. 12, 2007

(51) Int. Cl. C23C 28/02; B05D 5/12

(52) U.S. Cl. 205/187; 427/127

(57) ABSTRACT

A method is provided for manufacturing a magnetic steel component. An electroless nickel plating is formed on a substrate that includes magnetic steel. A thermal cycle is thereafter performed at a temperature that is sufficiently high to sinter the electroless nickel plating and thereby form a densified plating on the substrate. According to one embodiment, the thermal cycle includes a solid state diffusion sintering process wherein the substrate and the densified plating are heated to a temperature of at least about 1300° F. (about 704° C.) but.below the melting temperature of the electroless nickel plating. According to another embodiment, the thermal cycle includes a transient liquid phase sintering process wherein the substrate and the densified plating are heated at least to the melting temperature of the electroless plating.

### FIELD OF THE INVENTION

The present invention generally relates to magnetic steel that is used in the construction of aircraft and industrial components including solenoids and electric motors. More particularly, the present invention relates to wear and corrosion resistant coatings for magnetic steels to prevent damage during use of the components that may occur due to friction or corrosion as a result of operation and the operating environments.

### BACKGROUND OF THE INVENTION

Magnetic steel is used to manufacture electric motors and gas turbine engine components for aircraft and industrial applications. As just one example, solenoid actuated valves are also manufactured from magnetic steel. A solenoid valve includes a valve assembly that is coupled to a linear electromechanical solenoid. The assembly functions as the interface between electronic controller and pneumatic or hydraulic systems, and allows an electrical input to control pneumatic or hydraulic flow. Consequently, the solenoid-actuated valve, hereinafter referred to as a solenoid, is frequently used for controlling flow of fluids in turbine engines and aircraft pneumatic and hydraulic systems.

Because solenoids include moveable mechanical components and are tightly disposed in high pressure conduits though which contaminated and elevated temperature gases may flow, they are subject to wear and corrosion. Particularly, in order to optimize magnetic force, moving magnetic steel components often have small gaps between the moving magnetic pieces. Accordingly, the moving pieces may experience frictional wear and corrosion. Wear and corrosion of magnetic steel will inhibit proper motion of devices made therefrom.

A variety of coatings are used to enhance the wear and corrosion behavior for a solenoids, electric motor components, and other articles manufactured from magnetic steel that may experience friction due to relative motion between the articles and their adjacent components and corrosion due to environmental and control fluid composition during use. Electroplating is just one of many common methods for forming protective coatings on magnetic steel components. However, protective electroplated coatings developed for magnetic steels have limited field service due to inherent coating porosity and defects and subsequent penetration of a corroding electrolyte.

It is therefore desirable to provide improved coatings that function to both prevent corrosion and improve wear resistance to thereby increase the functional life of magnetic steel components. In addition, it is desirable to provide methods for forming such coatings. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for manufacturing a magnetic steel component. An electroless nickel plating is formed on a substrate that includes magnetic steel. A thermal cycle is thereafter performed at a temperature that is sufficiently high to sinter the electroless nickel plating and thereby form a densified plating on the substrate. According to one embodiment, the thermal cycle includes a solid state diffusion sintering process wherein the substrate and the densified plating are heated to a temperature of at least about 1300° F. (about 704° C.) but.below the melting temperature of the electroless nickel plating. According to another embodiment, the thermal cycle includes a transient liquid phase sintering process wherein the substrate and the densified plating are heated at least to the melting temperature of the electroless plating.

### BRIEF DESCRIPTION OF THE DRAWINGS

The present invention will hereinafter be described in conjunction with the following drawing figures, wherein like numerals denote like elements, and

FIG. 1 is a cross-sectional view of a magnetic steel component including a substrate coated with a metal strike;

FIG. 2 is a cross-sectional view of the magnetic steel component depicted in FIG. 1 following an electroless metal coating process;

FIG. 3 is a cross-sectional view of the magnetic steel component depicted in FIG. 2 following a thermal diffusion process;

FIG. 4 is a cross-sectional view of the magnetic steel component depicted in FIG. 3 after coating the diffused metal coating with a metal strike; and

FIG. 5 is a cross-sectional view of the magnetic steel component depicted in FIG. 4 after coating the diffused metal coating with a wear-resistant coating.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

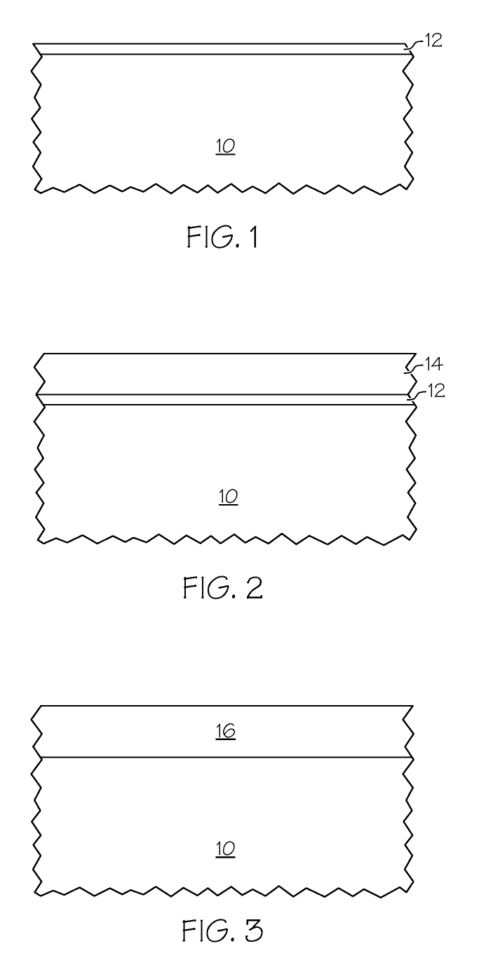

The present invention provides the advantages of using plating methods to form a metal layer as a corrosion resistance coating for magnetic steel components. The plating methods may be used to form a series of coatings in order to optimize the coating formulations and to concentrate particular metals in various portions of the plated coating. FIGS. 1 to 5 are cross-sectional views depicting a substrate 10 during different steps of a process in which a corrosion resistance coating and a wear resistance coating are formed thereon. Turning to FIG. 1, the substrate 10 includes magnetic steel, typically as the primary or sole substrate composition. An exemplary substrate 10 is a magnetic steel that forms an electric motor component or gas turbine engine component such as a solenoid.

According to an exemplary embodiment, a thin metal strike 12 is formed on the substrate 10 in order to provide a surface that has little to no oxide. The magnetic steel in the substrate 10 is highly susceptible to formation of metal oxides such as iron III oxide. Oxide formation tends to reduce adhesion of overlying coatings to the substrate 10, and further tends to reduce diffusion of metals between the substrate 10 and any overlying coatings during subsequent thermal processing. Consequently, the substrate 10 is coated with the strike 12, which is a metal coating applied using a deposition process that removes oxides of the magnetic steel and replaces the oxides with a thin metal layer. The metal layer may also form oxides, although they are less difficult to remove during the application of a thicker top coat compared to the thicker oxides commonly formed on the magnetic steel that is part of the substrate 10. Exemplary metal strike materials include copper and nickel. According to one embodiment, the metal strike 12 is formed by an electrolytic plating process until the strike material reaches a thickness of about 0.0001 to 0.0005 inches (about 2.54 to 12.7 micrometers).

As depicted in FIG. 2, an electroless nickel plating 14 is formed over the substrate 10. According to the embodiment in which the thin metal strike 12 is formed on the substrate 10 the electroless nickel plating 14 is formed directly on the metal strike 12, which provides a substantially oxide-free interface. The electroless nickel plating has a phosphorous content ranging between about 2 and 15 wt. %, with a preferred phosphorous content being about 7 wt. % since that is the phosphorous concentration at which desirable diffusion and interlayer bonding is obtained. Electroless nickel plating is an auto-catalytic reaction used to deposit a coating of nickel on a substrate. Unlike electroplating, it is not necessary to pass an electric current through the solution to form a deposit. Electroless nickel plating provides several advantages over electroplating. Free from flux-density and power supply issues, electroless nickel plating provides an even deposit regardless of workpiece geometry or surface conductivity. According to an exemplary embodiment, the electroless nickel plating 14 is formed to a thickness ranging between about 0.00005 and 0.005 inch (between about 1.27 and 127 micrometers). According to another exemplary embodiment, the electroless nickel plating 14 is covered with a thin electrolytic nickel plating. For example, a non-illustrated electrolytic nickel plating having a thickness ranging between about 0.0002 and 0.0003 inch (between about 5.1 and about 7.6 micrometers) may be optionally formed over the electroless nickel plating.

After forming at least the electroless nickel plating 14, a thermal cycle is performed. The plating 14 as originally formed has microscopic pores and defects, and includes an amorphous mixture of nickel and phosphorous. The plating process results in residual stress throughout the plating 14. The defects and the internal stresses within the plating are reduced by inter-atomic diffusion that is induced by heating the coating 14 at a sufficient temperature and for a sufficient time. The resulting coating has improved corrosion resistance.

Furthermore, performing a thermal cycle produces a metallurgical bond between the plating 14 and the substrate 10. Conventional coatings may spall off during service as they are mechanically bonded. According to the present invention, a thermal cycle is performed to prevent the plating 14 from spalling.

The time and temperature for the thermal cycle vary according to the electroless nickel plating thickness and composition. Furthermore, the thermal cycle temperature should be commensurate with an annealing temperature for the magnetic steel in the substrate 10. The thermal cycle produces a densified electroless nickel plating 16 as depicted in FIG. 3. According to the embodiment in which the thin metal strike 12 is formed on the substrate 10 the densified electroless nickel plating 16 includes diffused metal atoms from the thin metal strike 12. Furthermore, if an electrolytic nickel plating is deposited over the electroless nickel plating 14, diffused metal atoms from the electrolytic nickel plating are diffused into the densified electroless nickel plating 16. The densified electroless plating 16 with a thickness of less than even 0.001 inch (25.4 micrometers) provides excellent corrosion protection. In addition to providing the advantages of improved corrosion resistance by removing micropores and internal residual stresses from the as-deposited plating 14, the densified electroless nickel plating 16 is sufficiently thin to better maintain the efficiency of the electromagnetic component on which the plating 16 is formed when compared to conventional thicker coatings since the component's electromagnetic efficiency decreases as overlying layer thicknesses increase.

Two exemplary methods for forming the densified electroless nickel plating 16 are solid state diffusion sintering and transient liquid phase sintering. Either thermal process will effectively reduce the coating porosity by closing and sealing the pores. As a result, the corrosion resistance properties of the electroless nickel plating are improved. Solid state diffusion sintering is driven by the differential composition between the magnetic steel substrate 10 and the overlying plating 14. The differential is enhanced by the residual stress within the plating 14 caused by the mismatched grains of nickel and nickel phosphorus, and the gaps that the mismatched grains produce. Transient liquid phase sintering is performed at a higher temperature than solid state diffusion sintering in order to at least partially melt the eutectic composition in the plating 14 and thereby substantially eliminate the porosity within the plating 14 by capillary action.

Either of the solid state diffusion sintering process and the transient liquid phase sintering process is performed in a vacuum or an inert gas environment. An exemplary solid state diffusion process is performed by heating the substrate 10 with the electroless nickel plating 14 formed thereon to a temperature ranging between about 1300 and about 1600° F. (between about 704 and about 870° C.). As previously discussed, the thermal cycle temperature should also be commensurate with an annealing temperature for the substrate 10. The elevated temperature is maintained for a period ranging between about 1 minute and about 4 hours, depending on the thickness and composition of the electroless nickel plating 14 and the mechanism that is required to fuse the densified plating 16 to the substrate 10.

An exemplary transient liquid phase sintering process is performed at a higher temperature than the temperature for the solid state diffusion process. The thermal cycle is performed at a temperature that at least partially melts the electroless nickel plating material during transient liquid phase sintering. Capillary action causes the pores in the plating 14 to close. Densification of the coating occurs rapidly as a result of the partial melting of the electroless nickel plating 14. Also, increased diffusion of atoms between the substrate 10 and the plating 14, and the nickel strike 12 if included, is a result of performing a transient liquid phase sintering process instead of a solid state diffusion sintering process.

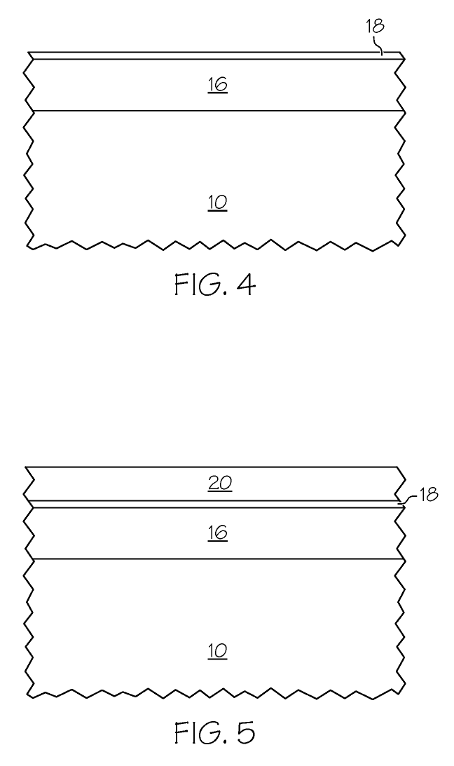

The densified electroless nickel plating 16, may also be formed by applying an additional coating over the electroless nickel plating 14 in FIG. 4 and diffusing the three layers together. According to an exemplary embodiment, a nickel plating having a thickness of about 0.0001 to 0.0005 inch (2.5 to 12.7 micrometers) is formed over the electroless nickel plating 14 and the three layers (i.e. the nickel strike 12, the densified electroless nickel plating 16, and the additional nickel plating) are diffused together to provide an outer layer that is rich in nickel content.

For many applications, particularly for components that experience occasional friction or contact with particles in flowing air or with other components, a wear resistant coating may be formed over the densified electroless nickel plating and, when included, over other overlying coatings such as an overlying metal strike 18. FIG. 5 is a cross-sectional view of the component depicted in FIG. 4 after coating the diffused metal coating 16 and the metal strike 18 with a wear-resistant coating 20. The coating 20 is a material that provides an outer surface having high wear resistance and a low friction coefficient. Some exemplary metals for the wear-resistant coating 20 include chromium and electroless nickel. Electroless nickel platings may be formed using a method that is similar to the process by which the plating 14 is formed. The electroless nickel plating may either include a phosphorus content (Ni—P) or a boron content (Ni—B). For either of such electroless nickel platings, a heat treatment preferably follows plating with the wear-resistant coating in order to harden the coating 20. For example, following formation of either a Ni—P or Ni—B plating, a thermal cycle at about 750° F. (about 400° C.) will harden the wear-resistant coating 20. The temperature and duration of the heating treatment will vary depending on the coating thickness and the coating material. For example, a coating formed from chromium does not require any subsequent heat treatment to be sufficiently hard and provide suitable wear resistance and low friction.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for manufacturing a magnetic steel component, comprising the steps of:
forming an electroless nickel plating on a substrate comprising magnetic steel; and
performing a thermal cycle at a temperature that is sufficiently high to sinter the electroless nickel plating and thereby form a densified plating on the substrate.

2. The method according to claim 1, wherein the thermal cycle comprises a solid state diffusion sintering process wherein the substrate and the densified plating are heated to a temperature of at least about 1300° F. (about 704° C.) but.below the melting temperature of the electroless nickel plating.

3. The method according to claim 1, wherein the thermal cycle comprises a transient liquid phase sintering process wherein the substrate and the densified plating are heated at least to the melting temperature of the electroless plating.

4. The method according to claim 1, wherein the step of forming the electroless nickel plating comprises forming a plating comprising a nickel-phosphorus material having between about 2 and 15 wt. % phosphorus.

5. The method according to claim 4, wherein the step of forming the electroless nickel plating comprises forming a plating comprising a nickel-phosphorus material having about 7 wt. % phosphorus.

6. The method according to claim 1, further comprising the step of:
forming a metal strike on the substrate before forming the electroless nickel plating.

7. The method according to claim 6, wherein the step of forming the metal strike comprises forming a layer comprising a metal selected from the group consisting of nickel and copper.

8. The method according to claim 1, further comprising the step of:
forming a metal strike on the densified plating.

9. The method according to claim 8, wherein the metal strike comprises nickel.

10. The method according to claim 1, wherein the step of forming the electroless nickel plating is performed until the electroless nickel plating reaches a thickness ranging between about 0.0001 and 0.005 inch.

11. The method according to claim 1, wherein the step of forming the electroless nickel plating is performed on a solenoid valve as the substrate.

12. The method according to claim 1, wherein the step of forming the electroless nickel plating is performed on an electric motor component as the substrate.

13. The method according to claim 1, further comprising the step of:
forming a wear-resistant metal coating on the densified plating.

14. The method according to claim 13, wherein step of forming the wear-resistant coating comprises forming a metal coating comprising a metal selected from the group consisting of a nickel-phosphorous alloy, a nickel-boron alloy, and chromium.

15. The method according to claim 13, further comprising the step of:
hardening the wear-resistant metal coating by heating the wear-resistant metal.

16. A method for manufacturing a magnetic steel component, comprising the steps of:
forming an electroless nickel plating on a substrate comprising magnetic steel;
forming an electrolytic nickel plating on the electroless nickel plating; and
performing a thermal cycle at a temperature that is sufficiently high to at least partially interdiffuse the electroless nickel plating and the electrolytic nickel plating, and to further sinter the electroless nickel plating and thereby form a densified plating on the substrate.

17. The method according to claim 16, wherein the thermal cycle comprises a solid state diffusion sintering process wherein the substrate and the densified plating are heated to a temperature of at least about 1300° F. (about 704° C.) but.below the melting temperature of the electroless nickel plating.

18. The method according to claim 16, wherein the thermal cycle comprises a transient liquid phase sintering process wherein the substrate and the densified plating are heated at least to the melting temperature of the electroless plating.

19. The method according to claim 16, further comprising the steps of:
forming a first metal strike on the substrate before forming the electroless nickel plating, the first metal strike being a metal selected from the group consisting of nickel and copper; and
forming a second metal strike comprising nickel on the densified plating.

20. The method according to claim 16, further comprising the steps of:
forming a wear-resistant metal coating on the densified plating, the wear-resistant metal comprising a metal selected from the group consisting of a nickel-phosphorous alloy, a nickel-boron alloy, and chromium; and
hardening the wear-resistant metal coating by heating the wear-resistant metal.
